(19) United States
(12) Patent Application Publication
(10) Pub. No.: US 2002/0107732 A1
(43) Pub. Date: Aug. 8, 2002

(54) System and method for providing a consumer aggregation service

(76) Inventors: Stephen J. Boies, Mahopac, NY (US); Samuel Dinkin, Austin, TX (US); Paul Andrew Moskowitz, Yorktown Heights, NY (US); Philip Shi-Lung Yu, Chappaqua, NY (US); Daniel P. Greene, Ossining, NY (US)

Correspondence Address: MORGAN & FINNEGAN, L.L.P., 345 Park Avenue, New York, NY, 10154, US

(21) Appl. No.: 09/779,214

(22) Filed: Feb. 8, 2001

(51) Int. Cl. G06F 17/60

(52) U.S. Cl. 705/14; 705/26

(57) ABSTRACT

A system and method is directed to provide a consumer aggregation service in plural network servers. The invention is directed to a computer-executable program for use in network servers which allows a service provider to collect coupons, discounts, and other deals for its registered users to use in making purchases online. The invention has particular utility in connection with internet service providers that provide access to the World Wide Web. However, the invention is not limited to use in this context, and can be used in a variety of different networking systems where goods are sold by merchants.

### FIELD OF THE INVENTION

The invention generally relates to business methods, and, more particularly, to a method and system for providing a consumer aggregation service.

### BACKGROUND OF THE INVENTION

The sale of Internet services is growing at an amazing rate. Business and governmental entities as well as individuals are increasingly relying upon the Internet for research, communication, entertainment and transactional purposes. The number of projected users expected to join the internet in the next few years is dramatically impacting the communications industry both from the standpoint of an opportunity to realize new business and as a concern due to the potential loss of traditional revenue sources.

Market and industry analysts alike, believe that the Internet will prove to be the most significant innovation in modern history since the light bulb and automobile. The method in which we perform daily business operations will be changed forever due to this new technology. Many technology based companies in the computer industry are scrambling to outline new products and services using and exploiting the Internet as a vehicle to increase market share and revenue, while increasing productivity and cutting operational costs.

In an effort to meet the above needs of digesting the vast amounts of information desired by users who surf the web, companies have designed millions of web pages to allow users to access, retrieve and utilize this information. Most companies have gone beyond merely supplying information about their organizations and are now actually marketing their products on the World Wide Web. In fact, a survey conducted by Goldman Sachs recently showed that the amount of online sales per week has surpassed the one billion dollar mark.

As an additional incentive to purchase that company's products through the internet, significant discounts, or coupons, are often offered to potential customers as they visit a company's web page or internet site. However, these discounts and coupons are typically offered to consumers who have purchased frequently enough from a certain internet business to warrant receiving a special coupon or discount. Consequently, consumers are often unable to take advantage of special discounts when they have a specific one-time purchase in mind on the internet. Additionally, if a consumer receives a coupon after purchasing from a particular site on the internet, the coupon will never be used if they never plan on returning to the site.

Currently, access to the Internet network is provided to users through connections to Internet servers. Such servers are typically maintained by an Internet Service Provider (ISP) who offers “use” of it's server(s) to customers on a pre-determined, subscription basis. Generally, each ISP serves a very large number of users. In fact, America Online, one of the nation's largest ISP, recently announced that it has over twenty-six million current subscribers.

Since each ISP has a very large user base, an ISP can, as a super-user representing all subscribers to its service, collect information based on the web-browsing of its users. The system and method is therefore directed to the problem of developing a consumer aggregation service which allows a service provider collect coupons, discounts, and other deals for its registered users to use in making their online purchases.

### SUMMARY

As set forth below, a need exists for a method and system to provide a consumer aggregation service which will collect coupons, discounts, and other bonuses for its registered users to use in making their online purchases. The method and system of the invention solves the problem. In particular, the invention is directed to a computer-executable program for use in a network service provider which enables the network service provider to collect coupons, discounts, and other deals for its registered users to use in making online transactions. While the invention has specific utility in connection with service providers that allow access to the World Wide Web, it can be used with other network service providers which provide access to servers where products or services are being sold.

In a preferred embodiment, users first register with the aggregation service at a specific registration web site. As part of the registration procedure, the user will input a name, a desired user name and password, and billing and shipping information. The registration information is then stored in a database so the user does not need to register again if they choose to use the service more than once.

Once the user is registered, the user can access the World Wide Web through portals provided by the aggregation service. At this time, the user's identity to other internet sites is replaces by the identity of the aggregation service. Thus, when the user visits a particular web site, the user's identity appears to be that of the aggregation service.

When a user visits a merchant site, the aggregation service checks to see if a bonus or coupon is available. If one is available to the user, the user is then directed by the aggregation service to the site identity having that bonus and the user can then continue shopping at the site.

If the user decides to make a purchase at one of the merchant sites accessible through the aggregation service, the user places the order as usual and any applicable bonus is figured into the cost of the item. However, once the user has entered and submitted their payment and shipping information, the user is diverted to the aggregation service's site. At this point, the aggregation service then bills the user's credit card for the purchase. If the charge is accepted by the user's credit card company, the aggregation service then submits its own shipping and payment information to the merchant site. Therefore, to the merchant site, it appears that the aggregation service is purchasing the item and the aggregation service is able to collect any additional coupons or bonuses awarded to the user due to the user's purchase.

The coupons or bonuses the aggregation service collects can take on a variety of different forms. For example, the bonus could be a certain dollar amount off of the price being offered by a merchant or a percentage discount. Additionally, since the aggregation service is making all of the purchases on behalf of its registered users, it will likely receive better bonuses or coupons from the merchants as a volume buyer. These coupons or bonuses would be added to the pool of available bonuses which registered users can trade in points, based on their purchase history, to acquire.

However, if registered users are making a large number of purchases from a certain vendor, the aggregation service could work out a deal with that vendor to provide bonuses, discounts, or coupons to all purchases made by the aggregation service and its registered users. Thus, a particular merchant might offer a volume discount or financial benefit to the aggregation service which the aggregation service could evenly distribute amongst all of its registered users. Such a financial benefit might be tied to the purchase of a specific product by the registered use. For example, if the registered user buys one product, the user can get a second at half price.

If a user does collect a bonus or coupon after a particular purchase, the user can see what coupons the aggregation service has collected by visiting a specific site controlled by the aggregation service. In one embodiment, the user can then decide whether to keep any coupons and bonuses and use them for a later purchase or turn them in for a specific number of points. The user can trade in any accumulated points to acquire coupons and bonuses which the aggregation service has accumulated or that other users have traded in for points.

In another embodiment, the user collects a certain number of points instead of coupons when the user makes a purchase. These points can then be traded in for coupons or bonuses the aggregation service has accumulated, including those acquired due to the user's purchases. This embodiment limits the potential for an infrequent user of the site to acquire and hold a coupon that the user does not intend to use for a long period of time, thereby making it impossible for other users to use the coupon.

### BRIEF DESCRIPTION OF THE DRAWINGS

The accompanying drawings illustrate certain embodiments of the invention.

FIG. 1 illustrates a system according to one embodiment of the present invention;

FIG. 2 illustrates a sample of the contents of the consumer database stored in the system shown in FIG. 1;

FIG. 3 illustrates a sample of the contents of the bonus database stored in the system shown in FIG. 1;

FIG. 4 illustrates a sample of the contents of the order database stored in the system shown in FIG. 1;

FIG. 5 illustrates a sample of the contents of the virtual consumer database stored in the system shown in FIG. 1;

FIG. 6 is a flowchart illustrating a registration process executed by the system shown in FIG. 1;

FIG. 7 is a flowchart illustrating a shopping process executed by the system shown in FIG. 1;

FIG. 8 is a flowchart illustrating a purchase data interception process executed by the system shown in FIG. 1;

FIG. 9 is a flowchart illustrating a bonus exchange process executed by the system shown in FIG. 1.

### DETAILED DESCRIPTION OF THE PREFERRED EMBODIMENTS

The system and method is directed to providing an aggregation service for developing a consumer aggregation service which allows a service provider collect coupons, discounts, and other deals for its registered users to use in making their online purchases. Although the system and method will be described in the context of the WWW, and more specifically internet service providers of WWW access, it is not limited to use in this context. Rather, the system and method can be used in a variety of different types of networking systems with a variety of different servers. For example, the system and method can be used in intranets and local area networks or in any networks where merchants sell goods.

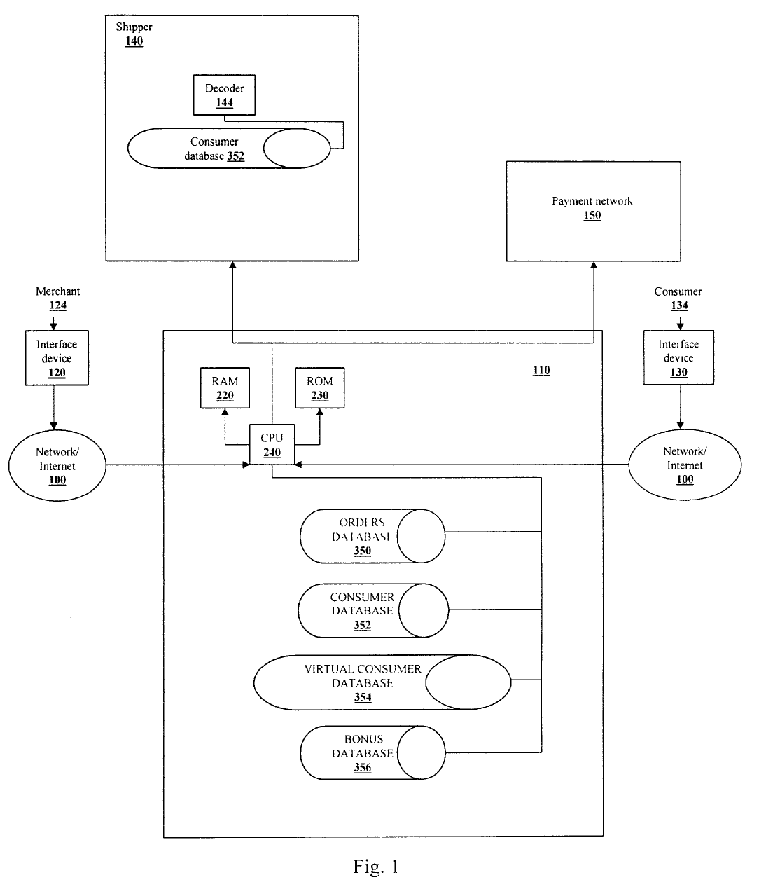

FIG. 1 shows one embodiment of a system incorporating the system and method. In this embodiment, the system includes a central controller 110, configured to receive information from one or more consumers 134 at remote computer terminals or interface devices 130 connected to the internet and World Wide Web 100. In addition, the central controller 110 will be configured to receive information from one or more merchants 124 at remote merchant terminals or interface devices 120 connected to the internet and World Wide Web 100.

Central controller 110 preferably comprises a processor based system with a CPU 240 with random access memory (RAM) 220 and read only memory (ROM) 230 which runs the aggregation service program and maintains databases for storing information related to its registered users and their online purchases. The CPU 240 is preferably a conventional microprocessor such as an Intel Pentium processor, and is electronically coupled to each of the central controller's 110 other elements. To carry out the functions and acts of the system and method, the CPU 240 executes the program code stored in one or more of RAM 220, ROM 230, or other storage devices.

Central controller 110 provides a graphical user interface (GUI) to consumers 134 at user interface devices 130 preferably connected electronically by the internet 100 or other network which allows the consumer to communicate with the aggregation service and browse the WWW and merchant sites. In one embodiment, the user interface device 130 may be a computer comprising one or more central processing units, one or more data storage devices, a monitor, a keyboard, and/or any other components that may allow a user to implement the commands of the software and hardware functions described herein.

Similarly, central controller 110 is connected electronically, preferably through the internet, to merchants 124 at merchant interface devices 120. The merchant interface device 120 is similar to the user interface device 130 in that it may be a computer comprising one or more central processing units and one or more data storage devices. A merchant's 124 information, including products for sale and bonuses or coupons, is typically stored in the merchant interface device 120 for a user 134 to access.

The central controller 110 is also connected to a shipping controller 140 and payment network 150 which are responsible for shipping merchandise to registered users and billing the registered users for their purchases. The central controller stores information relating to the consumers and their purchases in databases including the orders database 350, the consumer database 352, the virtual consumer database 354, and the bonus database 356.

Database Formats

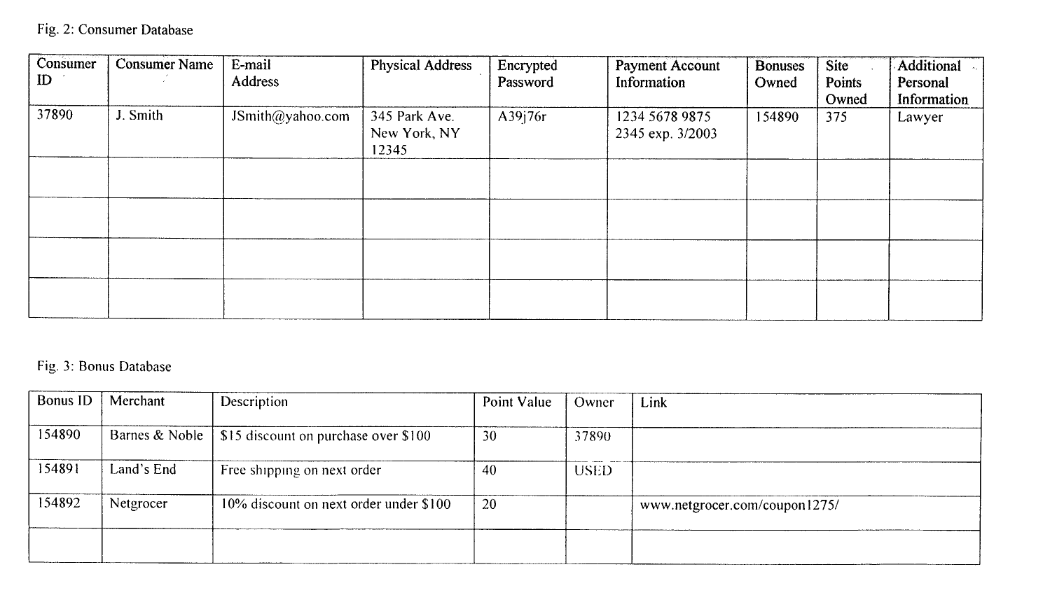

Samples of the contents of databases 350, 352, 354, and 356 are shown in FIGS. 2-5, respectively. The specific data and fields illustrated in these figures represent only one embodiment of the records stored in the databases of the system and method. In most cases, the fields shown in FIGS. 2-5 are self explanatory. It is to be understood that the data and fields, as well as the number of databases, can be readily modified from the described embodiment and adapted to provide variations for operating the system and method described.

Furthermore, each field may contain more or less information. For example, an address field may be divided into separate fields containing street address, apartment number, city, state, zip code, telephone number, and email.

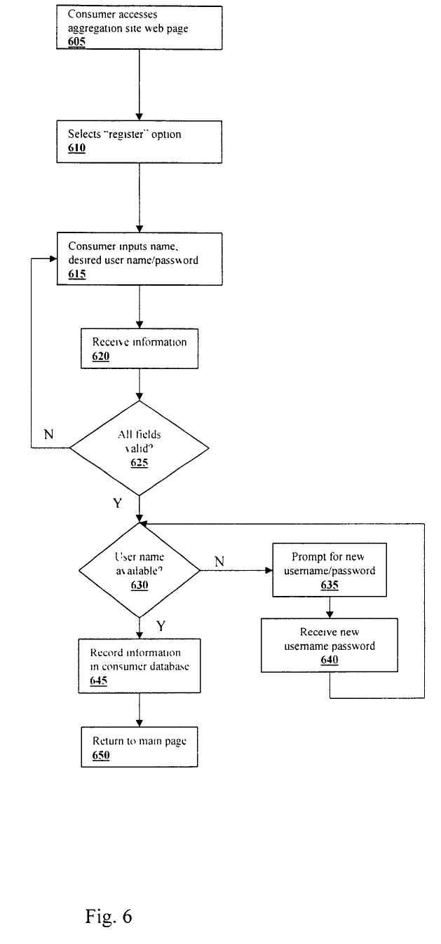

Consumer database 352 maintains, among other information, a compilation of all information provided by each consumer 134 in response to a series of prompts (fields) provided to the consumer 134 via user interface device 130 during a registration process that will be more fully explained in FIG. 6. In one embodiment, the information is entered by the consumer 134 into fields on a web page. Each record in consumer database 352 corresponds to one consumer.

FIG. 2 illustrates a sample record. As depicted in FIG. 2, consumer database 352 contains fields corresponding to, for example, consumer ID, consumer name, consumer address, encrypted password, payment billing information, site points owned, bonuses or coupons owned, e-mail address, and personal information (which may include, but is not limited to, consumer profession, title, interests, registration date, or question and answer for recalling a forgotten password). The data that is retrieved directly from the consumers' responses during registration to prompts on a webpage include the consumer name, the physical address, password, payment account information, email address, and any personal information.

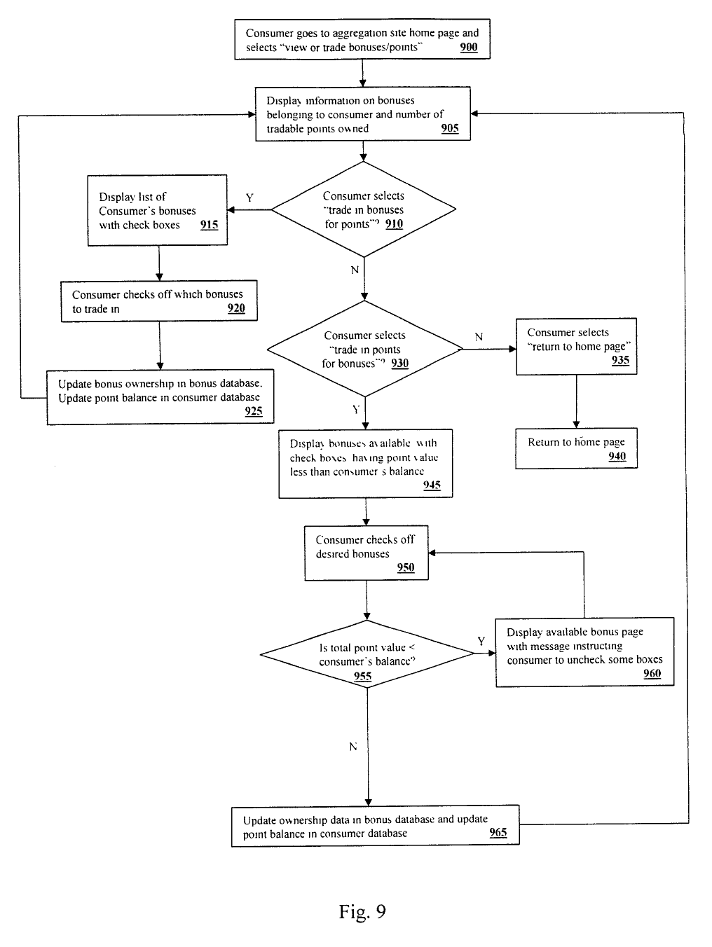

Many of the fields illustrated in FIG. 2 are self explanatory. The consumer ID field is a number assigned to each consumer 134 by the aggregation service to order the consumers in the database. The user name field corresponds to a name the consumer chooses which the consumer can use to log in to the service (the consumer ID can also be used to log in to the service in place of the user name). The bonuses owned field is a list of the specific bonuses the consumer can either use as the consumer makes purchases online or trade in through a process explained in FIG. 9. The site points owned field refers to the number of bonus points a particular consumer has acquired by trading in bonuses and coupons the consumer has received while making online purchases through the aggregation service. The procedure for trading in coupons and bonuses is also explained in FIG. 9.

The password is entered by the consumer 134 during registration and consists of any word or characters known to the consumer but not known to the general public. It is used, along with the consumer ID or user name, to log in to the aggregation service at the login screen. The central controller 110 uses the password to verify that the consumer 134 using the host site is in fact the same consumer who originally registered with the aggregation service. This prevents other users from logging in under the consumer's user ID and using the consumer's payment information and bonuses to make purchases.

Bonus database 356 contains information on all of the bonuses and coupons obtained by registered users of the aggregation service as they make their online purchases. FIG. 3 illustrates the fields making up bonus database 356, and they are more fully discussed below.

Like FIG. 2, most of the fields in FIG. 3 are self explanatory. The bonus ID field is a number which the aggregation service assigns to each bonus or coupon as it is obtained by a registered user or aggregation service. The point value field contains a number assigned by the aggregation service to each bonus based on the value of the bonus. In one embodiment, the greater the discount offered by the bonus, the higher the point value will be for the bonus. The actual point value of a bonus can be determined by the aggregation service (either manually or through a pre-determined algorithm) or in collaboration with the merchant sites.

In one embodiment, once a registered user collects a bonus and the aggregation service assigns a point value to it, the registered user can either keep the bonus or trade it in using the procedure explained in FIG. 9. If a bonus is kept by the user, the owner field will contain that registered user's consumer ID, which is stored in the consumer database 352 until it is used. When the registered user uses the bonus, the word “used” is entered

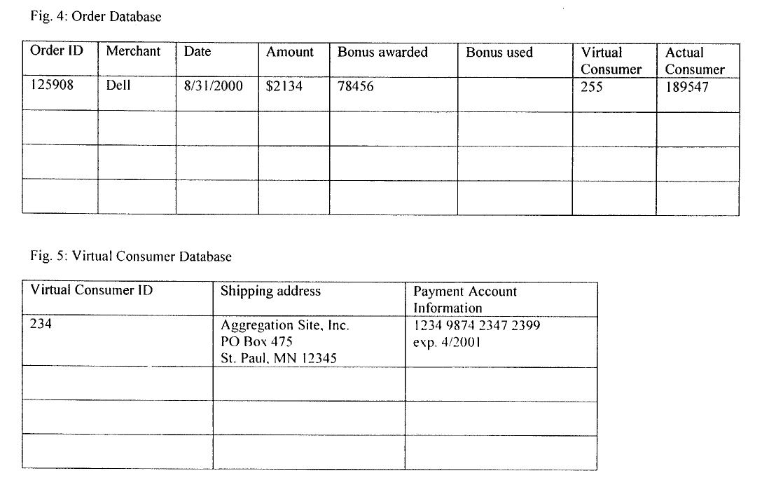

Order database 350 contains information on all the purchases made by registered users in which a bonus was awarded or used. FIG. 4 illustrates the fields making up order database 350, and they are more fully discussed below.

The order ID in order database 350 is a number assigned by the aggregation service to organize and refer to the orders in the database. The merchant field corresponds to the name of the seller in the purchase made by the registered user. The numbers in the bonus awarded field and bonus used field refer to the bonus ID stored in the bonus database 356. If no bonus is used or received for a particular transaction, both of these fields are left blank.

The virtual consumer field contains a number referring to a virtual consumer ID which is stored in the virtual consumer database 354 and explained in greater detail below. This indicates which virtual consumer was responsible for the actual purchase from the merchant.

Finally, the actual consumer field contains a number corresponding to a consumer ID which is stored in the consumer database 352. This allows the aggregation service to identify the consumer who should be ultimately billed in the owner field and the entry remains in the database so that the aggregation service can view a user's history. If the registered user decides to trade in the bonus, the owner field for that particular bonus will be blank, and other registered users will be able to trade in points to acquire the bonus through the procedure explained in FIG. 9.

Finally, the link field contains an address or other link to a special site on the network where the coupon or bonus is offered by the merchant. Often in online transactions, a merchant will provide a separate site for consumers to visit to activate any coupons or bonuses. The address to this site is typically provided to the consumer after a purchase is made or via electronic mail. When the consumer enters the merchant site via the address provided by the merchant, the bonus or coupon is automatically applied to the next purchase or order. Thus, if the consumer owns a bonus requiring a link address, the aggregation service can automatically send the consumer to the site containing the bonus when the consumer starts to browse at the merchant's site. Otherwise, if no link address is necessary, the field will remain blank. for the purchase and who should receive the purchased merchandise from the virtual consumer.

The virtual consumer database 354 contains information relating to the entity that is actually responsible for making the purchase directly from the merchant 124. Although the consumer 134 is the party ultimately paying for the purchased merchandise and receiving it, the virtual consumer appears to be the purchaser to the merchant. Since the virtual consumer is actually making the purchase of the merchandise bought by the consumer 134, the virtual consumer is able to collect any coupons or bonuses offered by the merchant for the aggregation service to distribute. Using this database, a single aggregation service can store multiple shipping addresses and billing accounts for making the purchases. Also, this database can be used to store information on multiple aggregation service providers so that they can link together to provide even greater services. This has the advantage of enabling the aggregation service providers to rout the purchased products more efficiently based on the location of the consumer 134. In addition, the aggregation service can use third parties to act as virtual consumers or shippers. For example, UPS could act as the shipper for a particular virtual consumer and have its address stored in the shipping address field, while the virtual consumer, potentially another third party, is still responsible for making the payment based on its information in the payment account information field.

FIG. 5 illustrates the fields making up the virtual consumer database 354. The virtual consumer ID contains a number assigned by the aggregation service to organize and refer to each virtual consumer in the database. The shipping address field refers to the shipping address of the virtual consumer which is where the purchased product will initially be shipped. This address could correspond to the address of a third party shipper, such as UPS, who will forward the item on to the consumer 134 when it receives it. Once the aggregation service has billed the consumer 134 for the purchase, the virtual consumer, or third party shipper, can forward the purchased product to the consumer.

The payment account information field is billing information of the virtual consumer who is initially billed for the purchase made by the consumer 134. The aggregation service is responsible for billing the consumer 134 and reimbursing the virtual consumer if it is a third party.

Consumer Registration Process

The consumer registration process is the process that a consumer 134 undergoes the first time that they visit the aggregation site. The process is responsible for, at least, obtaining personal information from the consumer 134 and creating space for the consumer in the consumer database 352. FIG. 6 illustrates one embodiment of the steps a consumer 134 takes to register with the aggregation service.

Referring to FIG. 6, the consumer 134 contacts the web site of the aggregation service provider (step 605) via user interface 130. On the web site, the consumer can then select to register with the service (step 610) to begin the registration process. In step 615, the controller 110 prompts the consumer 134 to enter all of the fields required to gather the necessary information which is recorded in the consumer database 352. This information includes the consumer's name, address, e-mail address, password, and such additional personal information as required by the aggregation service. In some embodiments, completion of the personal information fields may be optional.

Once the consumer 134 has entered all of the necessary information, the data is then submitted to the aggregation service provider which the controller 110 will receive (step 620) and use to create a new entry in the consumer database 352. The central controller 110 will then check if all the required fields have been completed by the consumer 134 (step 625). If it is not, the consumer will then be re-prompted to enter the missing required information (return to step 615) and steps 615-620 will be repeated until the consumer filled in all of the required information.

Once all of the required information has been entered, the controller 110 checks to see if the consumer's 134 selected user name is available. If it is not, the controller prompts the consumer to enter a new user name and password (step 635). The controller 110 receives this newly entered user name and password (step 640), and checks to see if it is available (step 630). Steps 630-640 are repeated until an available user name is entered. Once the controller 110 has a valid user name and password, the controller records the information in the consumer database 352 and the consumer 134 is returned to the aggregation service's home web site.

Consumer Use Process

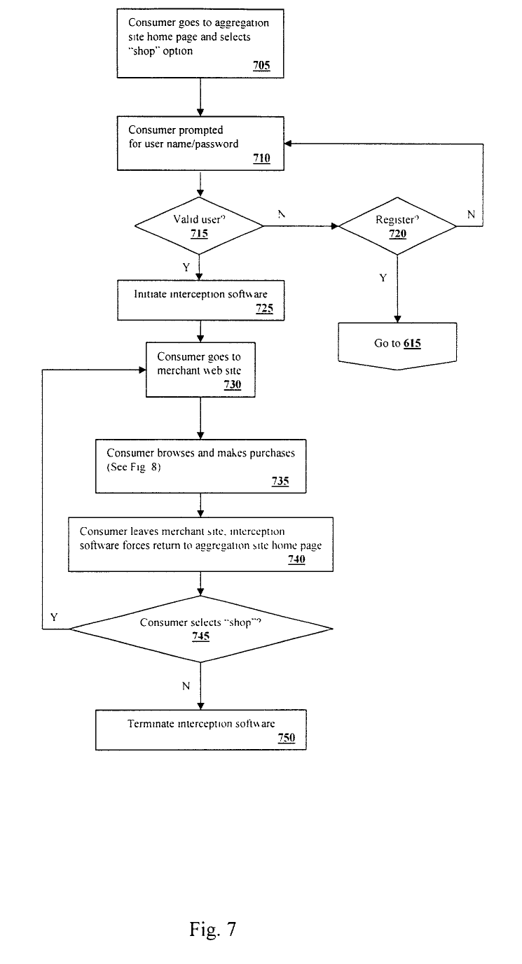

The consumer use process begins in the same manner as the consumer registration process. Referring to FIG. 7, the consumer 134 contacts the web site of the aggregation service via user interface 130 and selects the “shop” option (step 705). The consumer 134 then logs on to the aggregation service by entering the consumer ID or user name and the consumer's password at the prompts (step 710). The central controller 110 checks the entered information to see if the consumer is a valid user (step 715) and if the consumer is valid the consumer use process begins. Otherwise, the consumer is then asked to register with the service (step 720). If the consumer is a new user, the consumer will choose to register, and the registration process depicted in FIG. 6 will begin. If the consumer does not to choose to register, the consumer is prompted to reenter a user name/consumer ID and password to log in. Steps 710-720 are repeated until a valid user name/consumer ID and password are entered, or until the consumer chooses to register.

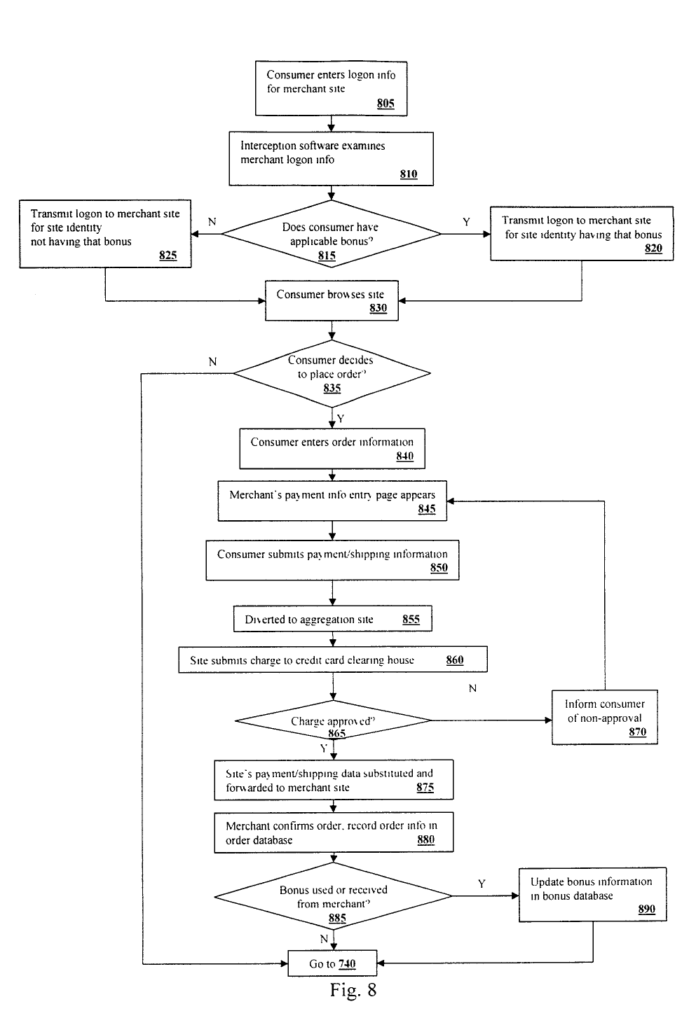

Once the consumer use process begins, the aggregation service initiates the interception software which will replace the registered user's individual identity with the aggregation service identity as the user browses World Wide Web sites (step 725). When the consumer visits a merchant site (step 730) and makes purchases (step 735), the interception software begins the process shown in FIG. 8, explained below. After the consumer leaves the merchant site, the interception software forces the user to return to the aggregation service's home page (step 740). At that point the user can either select the shop option in step 745 to continue shopping or exit the aggregation service which will terminate the interception software (step 750).

As mentioned before, FIG. 8 illustrates the steps the interception software takes when a registered user browses merchants online. First, in step 805, the registered user will enter logon info for the merchant site. The act of logging on to the merchant site can be accomplished in several different ways including simply entering the world wide web address or URL of the merchant to clicking on a link provided by the aggregation service.

Once the step of logging on to the merchant site is accomplished, the interception software of the aggregation service will examine the merchant logon info in step 810. In step 815, the aggregation service checks the consumer and bonus databases to see if the user owns a coupon for the merchant site the user is browsing. If the user does own a bonus for the merchant site, the aggregation service will check the bonus database to see if there is a link address for the particular bonus. If there is, in step 820 the interception software will divert the consumer to the link address where the bonus is activated and then the consumer can continue to shop. If there is no link address then the interception software simply routes the consumer on to the merchant's site (step 825).

At this point, the consumer can browse the site (step 830) to see if there is anything to buy. If the consumer decides to make a purchase in step 835, the consumer enters the order information (including the item, quantity, etc.) in step 840 and proceeds on to the merchant's payment information page (step 845). If no order is placed, the consumer returns to step 740 and returns to the aggregation service's site.

In one embodiment, in step 850, the consumer enters the payment information on the merchant's payment information page. When the information has been entered, the interception software of the aggregation service diverts the consumer to the aggregation site (step 855). The aggregation site takes the information entered by the consumer and attempts to charge the consumer's inputted credit card information for the amount of the order as given by the merchant site (step 860). In step 865, the aggregation service checks to see if the credit card of the consumer has been successfully charged. If it was not, in step 870 the consumer is informed of the non-approval and is sent back to the merchant payment info entry page (step 845) to reenter the information.

In another embodiment, as soon as the merchant's payment and shipping information screen comes up, the interception software of the aggregation service can divert the consumer to the aggregation site. Since the consumer is a registered user, the aggregation service can charge the consumer using the consumer's payment information stored in the consumer database 352. The aggregation service provides an option to the consumer to change any of the information (for example, if the consumer was shipping the purchased item directly to third party as a gift). Once the charge gets approved, the aggregation service follows the same process as in the preferred embodiment.

If the consumer's credit card is successfully charged, then in step 875 the aggregation site will substitute its billing and credit information for the consumer's and forward it to the merchant site. When the merchant confirms the order, the aggregation service records the order in the orders database 350 (step 880). In addition, if a bonus was used or acquired in making the purchase on behalf of the consumer (step 885), the aggregation service will update the bonus database 356 accordingly (step 890) and return the user to the aggregation service's home page. For example, if the consumer's purchase resulted in the aggregation service acquiring a bonus, the aggregation service will create a new Bonus ID for the bonus and place it in the bonus database 356.

In one embodiment, the user is initially indicated as the owner in the owner field of the bonus database 356. In this case, the user can then either use the bonus or trade it in for points (explained in FIG. 9). In an another embodiment, the user receives points (stored in the site points owned field in the consumer database illustrated in FIG. 2) for the purchase which can be traded in for coupons on the aggregation site (again, as explained in FIG. 9). In yet another embodiment, the user can receive points for a purchase based on the purchasing history of the user, regardless of whether the user received a coupon or bonus for the particular transaction. Under this embodiment, users are rewarded based on their usage of the aggregation service and extensive purchasing history.

FIG. 9 illustrates the steps a registered user takes in trading in coupons for site points and vice versa. In step 900, the user goes to the aggregation service's home page (after logging in) and chooses to view or trade in bonuses/points. The aggregation service then displays information on all of the bonuses belonging to the consumer and the number of site points owned (step 905). The user can then select to trade in bonuses for points (step 910) or trade in points for bonuses (step 930). Users can choose to return to the aggregation service's home page at any time if they don't want to make a trade (steps 935 and 940).

Otherwise, if the user chooses to trade in bonuses for points (step 910), a list of all the bonuses currently owned by the user and their trade-in value will be displayed with check boxes (step 915). The user will simply check off which bonuses to trade in (step 920) and the aggregation service will then update the bonus database 356 and consumer database 352 with the new information (step 925). Referring to FIG. 3, the owner field of any bonuses that have been traded in will be made blank. Referring to FIG. 2, the site points owned field for the consumer trading in the bonus will be updated showing the additional points earned for trading in the bonus.

If the user chooses to trade in points for bonuses (step 930), the aggregation service will display the bonuses currently available, which includes all those bonuses in the bonus database 356 that have a blank owner field, along with the check boxes and the point value assigned to each available bonus (step 945). The user simply checks off the desired bonuses (step 955) and as long as the user has enough site points owned (step 955) the aggregation service will update the bonus database 356 and consumer database 352 with the new information (step 965). Otherwise, if the user does not have enough points to trade-in for the bonuses the user has checked off, the aggregation service displays an appropriate message to the user and returns the user to the web page with the bonuses and check boxes so that the user can uncheck some boxes (step 960).

The above description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein.

What is claimed is:

1. A method to provide a consumer aggregation service on a network service provider comprising the steps of:
registering users with the aggregation service;
granting the registered user access to the World Wide Web through the aggregation service;
replacing the registered user's individual identity with the aggregation service identity as the user browses World Wide Web sites.

2. The method of claim 1, further comprising the steps of:
receiving transaction information for at least one registered user;
intercepting an electronic merchandise order placed by the registered user with a merchant through an electronic network;
charging the registered user for the order;
executing the order with the merchant on the registered user's behalf so that the aggregation service's identity is charged by the merchant for the order; and
storing information regarding each purchase in a database.

3. The method of claim 2, wherein the aggregation service ships the purchased product to the registered user once the purchased product is received.

4. The method of claim 2, wherein the aggregation service gives the shipping address of the registered user to the merchant so that the purchased product may be shipped directly from the merchant to the registered user.

5. The method of claim 1, wherein the aggregation service collects coupons or bonuses from web sites based on the web surfing of its registered users and stores them in a database.

6. The method of claim 2, wherein the aggregation service collects coupons or bonuses from a merchant because of the purchase made by the registered user and stores them in a database.

7. The method of claim 6, wherein the aggregation service awards a registered user coupon or bonus points based on the purchase made by the registered user.

8. The method of claim 7, wherein the aggregation service allows the registered user to trade in coupon or bonus points to obtain coupons or bonuses collected by the aggregation service.

9. The method of claim 2, wherein the aggregation service obtains financial benefits from a supplier or merchant based on the aggregate purchase volume at the supplier's or merchant's site.

10. The method of claim 9, wherein the financial benefit can be a volume discount offered to registered users of the aggregation service.

11. The method of claim 9, wherein the financial benefit can be an upgrade on the method of shipping.

12. The method of claim 9, wherein the distribution of the financial benefit to registered users can be based on the amount of purchases made by registered users in the past.

13. The method of claim 9, wherein the financial benefit can be distributed evenly to all registered users purchasing a specific product.

14. The method of claim 9, wherein the distribution of the financial benefit can be tied to a special purchase program, such as buying one product allows the registered user to get a second product at half price.

15. The method of claim 1, wherein the aggregation service preserves the anonymity of its registered users by referring to them by assigned ID numbers.

16. The method of claim 2, wherein a shipping company ships the purchased product to the registered user once the purchased product is received.

17. The method of claim 15, wherein shipping address of the registered user is only decodable to a physical address by the shipping company.

18. The method of claim 2 further comprising the step of permitting the registered user to specify the maximum price of items the user is interested in purchasing.

19. The method of claim 1, wherein the aggregation service may be comprised of multiple aggregation sites all connected through a central controller.

20. The method of claim 19, wherein the aggregation sites are controlled by a third party to the aggregation service.

21. The method of claim 1, wherein the registered user's information is stored in a database.

22. The method of claim 2, wherein the information regarding each purchase is stored in a database.

23. Computer executable software code stored on a computer readable medium, the code for providing a consumer aggregation service on a network service provider, comprising:
code to register users with the aggregation service;
code to grant the registered user access to the World Wide Web through the aggregation service;
code to replace the registered user's individual identity with the aggregation service identity as the user browses World Wide Web sites.

24. The computer executable code of claim 21, further comprising:
code to receive transaction information for at least one registered user;
code to intercept an electronic merchandise order placed by the registered user with a merchant through an electronic network;
code to charge a registered user for the orders; and
code to execute the order with the merchant on the registered user's behalf so that the aggregation service's identity is charged by the merchant for the order.

25. A computer system for providing a consumer aggregation service on a network service provider, comprising:
a memory having at least one region for storing computer executable program code; and
a processor for executing the program code stored in memory, wherein the program code includes:
code to register users with the aggregation service;
code to grant the registered user access to the World Wide Web through the aggregation service
code to replace the registered user's individual identity with the aggregation service identity as the user browses World Wide Web sites.

26. The computer system of claim 25, further comprising:
code to receive transaction information for at least one registered user;
code to intercept an electronic merchandise order placed by the registered user with a merchant through an electronic network;
code to charge a registered user for the orders; and
code to execute the order with the merchant on the registered user's behalf so that the aggregation service's identity is charged by the merchant for the order.
